(19) United States
(12) Patent Application Publication
(10) Pub. No.: US 2006/0039515 A1
(43) Pub. Date: Feb. 23, 2006

(54) Method and apparatus for estimating SFO in digital receiver

(75) Inventors: Dong Geun Lee, Seoul (KR); Tae Won Lee, Gyeonggi-do (KR)

Correspondence Address: JONATHAN Y. KANG, ESQ.;LEE, HONG, DEGERMAN,, KANG & SCHMADEKA, 801 S. Figueroa Street, 14th Floor, Los Angeles, CA, 90017, US

(73) Assignee: LG Electronics Inc.

(21) Appl. No.: 11/205,671

(22) Filed: Aug. 17, 2005

(30) Foreign Application Priority Data
Aug. 18, 2004 (KR) 10-2004-0065130

(51) Int. Cl. H04L 7/00; H04K 1/10

(52) U.S. Cl. 375/355; 375/260

(57) ABSTRACT

A method and apparatus for estimating a sampling frequency offset (SFO) in a digital receiver is disclosed. The method for estimating the SFO in the digital receiver to perform sampling synchronization includes the steps of: a) extracting a current scattered pilot contained in a single OFDM (Orthogonal Frequency Division Multiplexing) symbol interval; b) calculating a phase value using both the extracted current scattered pilot and a delay value acquired when the current scattered pilot is delayed by four symbol intervals; and c) estimating an SFO value using the calculated phase value. Therefore, the method correctly estimates the SFO value using the scattered pilot as compared to a conventional estimation method based on a continual pilot (CP), and reduces a jittering range caused by overshoots using a zero-forcing algorithm, such that it solves an SFO estimation failure caused by serious phase distortion.

### CROSS REFERENCE TO RELATED APPLICATIONS

Pursuant to 35 U.S.C. § 119(a), this application claims the benefit of earlier filing date and right of priority to Korean Patent Application No. 10-2004-0065130, filed on Aug. 18, 2004, the content of which is hereby incorporated by reference herein in its entirety.

### BACKGROUND OF THE INVENTION

1. Field of the Invention

The present invention relates to a digital receiver, and more particularly, to a method and apparatus for estimating an SFO (Sampling Frequency Offset) applicable to an OFDM (Orthogonal Frequency Division Multiplexing) digital receiver.

2. Discussion of the Related Art

Generally, a DVB-T (Digital Video Broadcasting-Terrestrial) system and a DVB-H (DVB-Handheld) system, which act as the European transmission standard for terrestrial digital TV have generally selected an OFDM (Orthogonal Frequency Division Multiplexing) transmission scheme. It is well known in the art that the OFDM transmission scheme has very strong resistance to channel distortion caused by multiple paths (also called a multi-path) in a wireless broadband broadcast system.

On the other hand, the OFDM transmission scheme has very weak resistance to synchronization. Therefore, if accurate synchronization is not established between a transmitter and a receiver, distortion of a reception signal occurs. In order to solve the above-mentioned problem, many developers have conducted intensive research into an improved OFDM transmission scheme.

Particularly, if the receiver does not correctly perform sampling synchronization, an ISI (Inter Symbol Interference) and a constellation rotation may occur in a reception signal, such that the receiver cannot demodulate the reception signal. In order to solve the above-mentioned problem, there has been newly proposed a method for estimating an SFO (Sampling Frequency Offset) using a CP (Continual Pilot) shown in FIG. 1.

FIG. 1 shows general CP positions. As shown in FIG. 1, 45 pilots are employed during a 2k mode, and 177 pilots are employed during an 8k mode.

For example, in the case of the 2k mode, a total of 1705 data subcarriers are present in one OFDM symbol interval. A pilot is located at each of subcarrier positions, for example, 0-th, 48-th, and 54-th subcarrier positions, etc. In this case, the pilot is positioned at the same subcarrier positions as the above subcarrier positions in the next OFDM symbol, such that the pilot will be referred to as a Continual Pilot (CP).

A method for calculating the SFO using the above-mentioned CP information shown in FIG. 1 is shown in FIG. 2.

FIG. 2 is a block diagram illustrating a conventional SFO estimation system.

The above-mentioned conventional SFO estimation method will hereinafter be described with reference to FIG. 2. Firstly, the SFO estimation system receives a single signal Z_{1,k}. The Z_{1,k} signal is indicative of a k-th subcarrier in a first OFDM symbol. For example, in the case of the 2k mode shown in FIG. 1, the Z_{1,k} signal is indicative of one pilot from among a plurality of pilots (i.e., 0-th, 48-th, and 53-rd symbols, etc.) in the first OFDM symbol.

The Z_{1,k} signal is converted into another signal of Z_{1-1,k} via a delay 10. The Z_{1-1,k} signal is converted into a conjugate root signal of Z*_{1-1,k} via a conjugate calculator 3.

Correlation between the Z_{1,k} signal and the Z*_{1-1,k} signal is performed by a multiplier 5, such that the multiplier 5 outputs a phase information signal of x_{1,k}. By the following equation 1 performed by a phase estimator 7, the phase information signal of x_{1,k} acquires a total of 45 phase data units in the case of the 2k mode, and acquires a total of 177 phase data units in the case of the 8k mode.

$${tan}^{- 1} \frac{Re ( {x}_{l , k} )}{Im ( {x}_{l , k} )} \qquad [ Equation 1 ]$$

An SFO calculator 9 calculates a slope between phase data units using the phase data generated from the phase estimator 7, and calculates a mean slope, such that it calculates the SFO value.

The above-mentioned conventional SFO estimation method acquires correlation between two OFDM symbols, acquires a phase on the basis of the acquired correlation, and calculates a change rate of the acquired phase, such that it estimates the SFO value.

However, the above-mentioned SFO estimation method may incur SFO estimation complexity due to irregular overshoots of the CP, and may have difficulty in acquiring sufficient phase information due to the above-mentioned limited number of continual CPs (i.e., 45 phase data units in the 2k mode, and 177 phase data units in the 8k mode).

Particularly, the conventional SFO estimation method has difficulty in estimating a correct SFO when irregular overshoots occur due to a deep fading phenomenon.

The above-mentioned irregular overshoots do not affect the SFO in an acquisition mode of a sampling frequency, but they greatly affect the SFO in a tracking mode of the sampling frequency as shown in FIG. 3.

FIG. 3 shows a plurality of SFO values estimated in acquisition and tracking modes of the sampling frequency. As shown in FIG. 3, it can be recognized that a jittering range increases if overshoots occur in the tracking mode.

In this manner, if the jittering range increases due to the overshoots in the tracking mode, the increased jittering range has a negative influence upon a method for compensating for a sampling frequency by estimating a correct SFO.

### SUMMARY OF THE INVENTION

Accordingly, the present invention is directed to a method and apparatus for estimating an SFO in a digital receiver that substantially obviates one or more problems due to limitations and disadvantages of the related art.

An object of the present invention is to provide a method for estimating an SFO using a scattered pilot instead of a CP.

Another object of the present invention is to provide an SFO estimation method for reducing a jittering range caused by overshoots in a frequency tracking mode.

A still another object of the present invention is to provide an apparatus for compensating for a sampling frequency using the estimated SFO.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for estimating an SFO (Sampling Frequency Offset) in a digital receiver to perform sampling synchronization, comprises the steps of: a) extracting a current scattered pilot contained in a single OFDM (Orthogonal Frequency Division Multiplexing) symbol interval; b) calculating a phase value using both the extracted current scattered pilot and a delay value acquired when the current scattered pilot is delayed by four symbol intervals; and c) estimating an SFO value using the calculated phase value.

Preferably, the step b) for calculating the phase value includes the steps of: b1) correlating the current scattered pilot with the delay value acquired when the current scatter pilot is delayed by four symbol intervals; and b2) performing an arctangent operation on the resultant correlation value to acquire a desired phase.

Preferably, the step c) for estimating the SFO value includes the steps of: c1) receiving the estimated phase value, and determining the presence or absence of phase overshoots on the basis of the received phase value; c2) if the phase overshoots occur, compulsorily setting the estimated phase value to zero, and storing the resultant phase value; and c3) calculating the SFO value using the stored phase value.

Preferably, the step c1) for determining the presence or absence of the phase overshoots includes the steps of: comparing a magnitude of the estimated phase value with that of a predetermined standard deviation, and determining the presence or absence of the phase overshoots according to the comparison result.

Preferably, the step c1) for determining the presence or absence of the phase overshoots is performed when a current frequency estimation mode is a tracking mode.

Preferably, the step c3) for calculating the SFO value includes the steps of: c3-1) dividing the stored phase value into a left-half (LH) phase value and a right-half (RH) phase value on the basis of a center subcarrier, and accumulating each of the LH phase value and the RH phase value; and c3-2) calculating a difference between the accumulated LH and RH phase values, and calculating the SFO value.

In another aspect of the present invention, there is provided an apparatus for estimating a sampling frequency offset (SFO) in a digital receiver, comprising: a phase estimator for receiving a scattered pilot contained in an OFDM (Orthogonal Frequency Division Multiplexing) symbol interval, and estimating a phase value using both a scattered pilot contained in a single symbol and a delay value acquired when the scattered pilot is delayed by four symbol intervals; and an SFO calculator for calculating an SFO value using the estimated phase value.

In yet another aspect of the present invention, there is provided an apparatus for estimating a sampling frequency offset (SFO) in a digital receiver, comprising: a delay for receiving a scattered pilot contained in a single OFDM (Orthogonal Frequency Division Multiplexing) symbol interval, and delaying the received scattered pilot by four symbol intervals; a conjugate calculator for calculating a conjugate root value of an output value of the delay; a multiplier for correlating an output value of the conjugate calculator with the received scattered pilot; a phase estimator for performing an arctangent operation on an output value of the multiplier to acquire a phase value; and an SFO calculator for receiving an output value of the phase estimator, storing the received output value of the phase estimator during a predetermined interval, and calculating an SFO value using the stored phase value.

Preferably, the SFO calculator determines whether the presence or absence of phase overshoots in a tracking mode of a sampling frequency, and performs a zero-forcing operation when the presence of the phase overshoots is determined.

Preferably, the presence or absence of the phase overshoots is determined by comparing the estimated phase value with a predetermined standard deviation.

In yet another aspect of the present invention, there is provided a digital receiver apparatus, comprising: a resampler for performing a sampling process on a received signal according to the calculated SFO value; a guard interval removal unit for removing a guard interval of the received signal from a time domain; a Fast Fourier Transform (FFT) unit for converting a time-domain signal into a frequency-domain signal; and an SFO compensator for calculating the SFO value using a scattered pilot contained in an OFDM (Orthogonal Frequency Domain Multiplexing) symbol so as to perform correct sampling synchronization on the frequency-domain signal.

Preferably, the SFO compensator includes: a pilot extractor for extracting a scattered pilot signal from the frequency-domain signal; a timing error detector for receiving the extracted scattered pilot signal, estimating a phase value using both the scattered pilot contained in a single symbol and a delay value acquired when the scattered pilot is delayed by four symbol intervals, and calculating the SFO value using the estimated phase value; a loop filter (L/F) for receiving the SFO value, and accumulatively compensating for the received SFO value; and a numerical controlled oscillator (NCO) for controlling a sampling frequency upon receiving the compensated SFO value from the L/F unit.

Preferably, the digital receiver is a DVB-T (Digital Video Broadcasting-Terrestrial) system or a DVB-H (DVB-Handheld) system.

Therefore, the present invention correctly estimates the SFO value using the scattered pilot as compared to the conventional estimation method based on a CP, and reduces a jittering range caused by overshoots using a zero-forcing algorithm, such that it solves an SFO estimation failure caused by serious phase distortion.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows general CP positions;

FIG. 2 is a block diagram illustrating a conventional SFO estimation system using a CP;

FIG. 3 shows a conventional plurality of SFO values estimated in acquisition and tracking modes of the sampling frequency;

FIG. 4 shows a pilot insertion pattern according to the present invention;

FIG. 5 is a conceptual diagram illustrating a correlation algorithm using a scattered pilot according to the present invention;

FIG. 6 is a block diagram illustrating an SFO estimation system using a scattered pilot according to the present invention;

FIG. 7 is a flow chart illustrating an SFO estimation algorithm according to the present invention;

FIG. 8a is a graph illustrating a phase variation in the case of using a scattered pilot according to the present invention;

FIG. 8b is a graph illustrating a conventional phase variation in the case of using a CP;

FIG. 9 shows estimated SFO values when phase overshoots are zero-forced in a tracking mode according to the present invention; and

FIG. 10 is a block diagram illustrating an OFDM receiver according to the present invention.

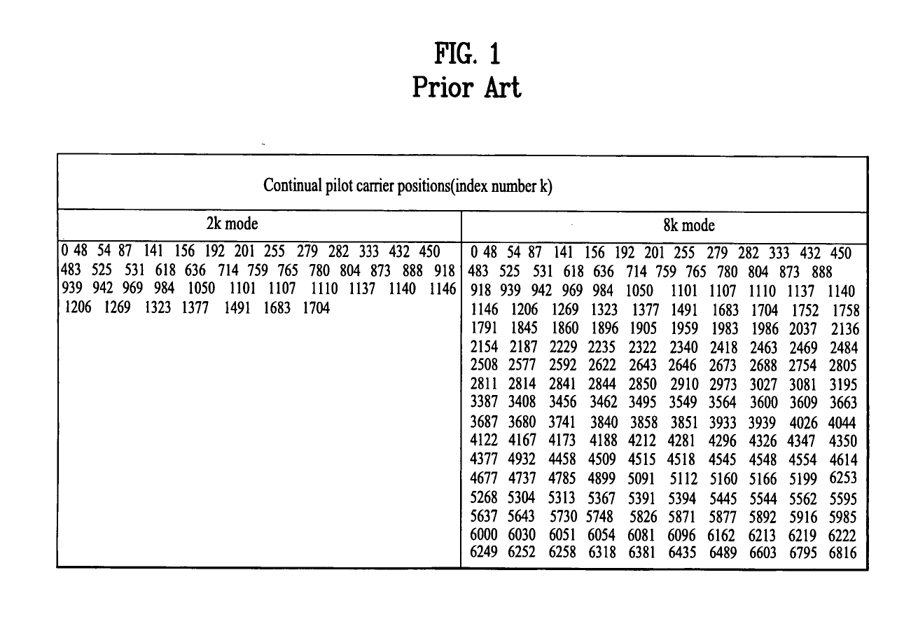

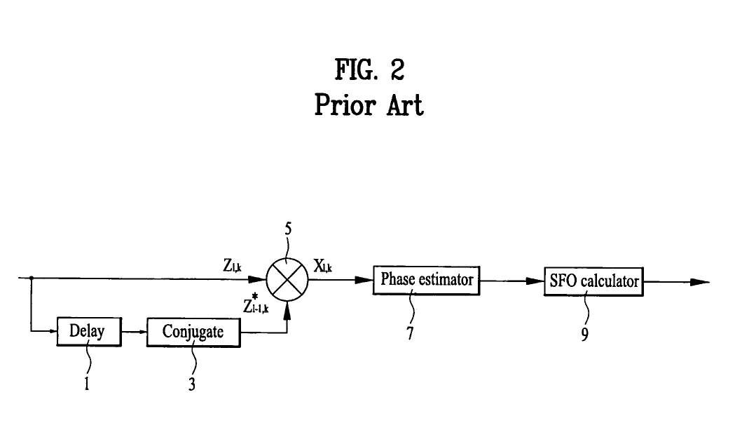

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

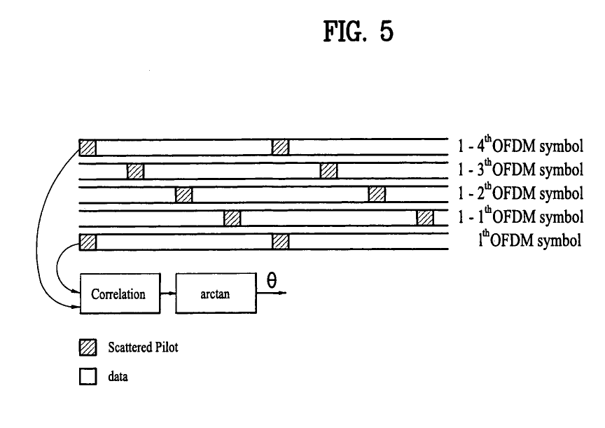

FIG. 4 shows a pilot insertion pattern according to the present invention;

Pilot arrangement shown in FIG. 4 is indicative of a predetermined pattern prescribed in a DVB-H transmission standard. The above-mentioned pilot arrangement is largely classified into a continual pilot (CP) arrangement and a scattered pilot arrangement, such that it is positioned between data subcarriers of an OFDM symbol.

The CP is located at the same subcarrier positiones as the above subcarrier positions in each OFDM symbol. The scattered pilot includes 12 subcarrier intervals, and is repeated at intervals of a predetermined time corresponding to four OFDM symbols.

Therefore, the scattered pilots may have many more phase information units than those of a CP, as can be seen from FIG. 4. A constant interval is provided among the scattered pilots, resulting in less complexity in hardware implementation of the scattered pilots.

However, the scattered pilots are arranged at different positions between two continual OFDM symbols, differently from the CP. According to the present invention, each scattered pilot is delayed during four OFDM symbol intervals, and is then correlated with a current OFDM symbol, its detailed description will hereinafter be described with reference to FIG. 5.

FIG. 5 is a conceptual diagram illustrating a correlation algorithm using a scattered pilot according to the present invention.

As shown in FIG. 5, the scattered pilot has iterative patterns at intervals of a predetermined time corresponding to four OFDM symbols, such that it correlates a first OFDM symbol with first to fourth OFDM symbols generated when the first OFDM symbol is delayed four times.

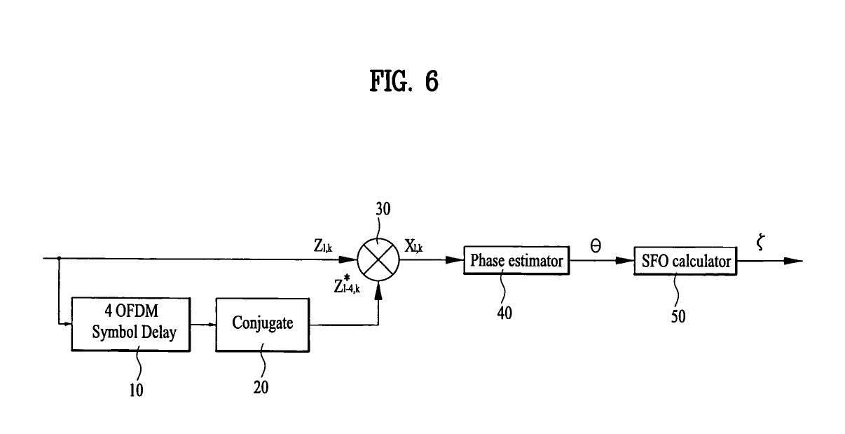

Therefore, correlation between OFDM symbols in which the same scattered pilot pattern occurs is provided, and an arc data value of the correlated data is calculated, such that desired phase information can be acquired. A detailed description will hereinafter be given with reference to FIG. 6.

FIG. 6 is a block diagram illustrating an SFO estimation system using a scattered pilot according to the present invention.

As shown in FIG. 6, the SFO estimation system receives a single signal of Z_{1,k}. The Z_{1,k} signal is indicative of a k-th pilot in a first OFDM symbol.

The Z_{1,k} signal is converted into a delayed signal of Z_{1-4,k} delayed for four symbol intervals via a “4 OFDM symbol delay” 10. The Z_{1-4,k} signal is converted into a conjugate root signal of Z*_{1-4,k} via a conjugate calculator 20.

Correlation between the Z_{1,k} signal and the Z*_{1-4,k} signal is performed by a multiplier 30, such that the multiplier 30 outputs a phase information signal of x_{1,k}. A phase estimator 40 calculates an arctangent value shown in Equation 1 using the above-mentioned phase information of x_{1,k}, such that a total of 142 phase data units are acquired in the 2k mode and a total of 568 phase data units are acquired in the 8k mode.

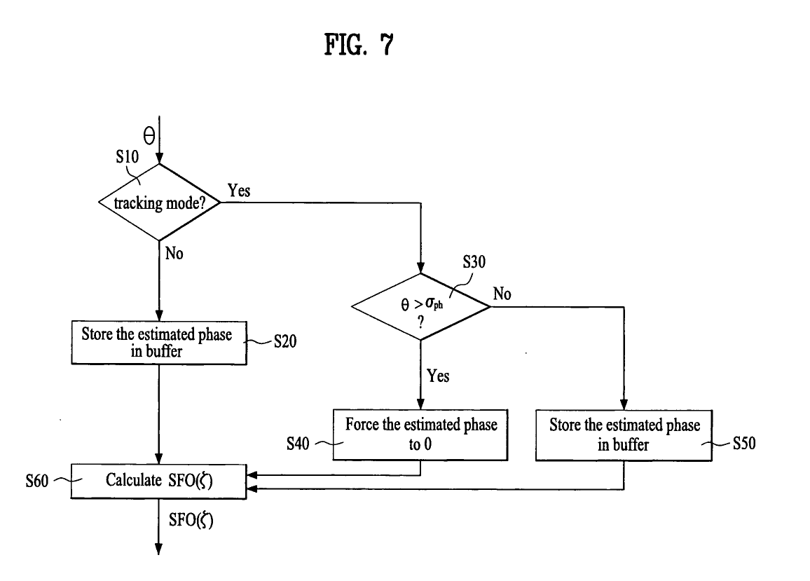

The SFO calculator 50 calculates an SFO value using the phase data acquired from the phase estimator 40, such that it estimates the SFO value. An algorithm for controlling the SFO calculator 50 to estimate the SFO value is shown in FIG. 7. An SFO estimation method will hereinafter be described with reference to FIG. 7.

FIG. 7 is a flow chart illustrating an SFO estimation algorithm according to the present invention.

As shown in FIG. 7, upon receiving a phase θ from the phase estimator 40, the SFO calculator 50 determines whether a current frequency estimation mode is equal to a tracking mode at step S10.

If the current frequency estimation mode is not equal to the tracking mode at step S10, the phase θ acquired from the phase estimator 40 is stored in a buffer contained in the SFO calculator 50 at step S20.

In this case, if the current frequency estimation mode is equal to the tracking mode at step S10, it is determined whether the estimated phase θ is higher than an input standard deviation σₚₕ at step S30. Preferably, the magnitude of the standard deviation is experimentally set to 0.5 rad.

If the magnitude of the estimated phase is higher than that of the standard deviation, it is determined that overshoots occur due to a deep fading phenomenon in the tracking mode, such that the estimated phase is compulsorily set to zero. The above-mentioned operation is called a zero-forcing operation.

In more detail, the estimated phase is compulsorily set to zero, such that the resultant estimated phase is stored in the buffer contained in the SFO calculator 50 at sep S40. By the above-mentioned operations, phase overshoots are zero-forced in the tracking mode, such that an SFO can be correctly estimated.

If the magnitude of the estimated phase is equal to or less than that of the standard deviation at step S30, it is determined that no overshoot occurs, such that the estimated phase is stored in the buffer contained in the SFO calculator 50 without any change.

By the above-mentioned operations, the phase estimator 40 correlates a pilot value prior to four symbols with a current pilot value to acquire a desired phase θ, such that the phase θ is collected during a single symbol interval.

The collected phase value is classified into a left-half (LH) phase value and a right half (RH) phase value on the basis of a center subcarrier. The LH phase value and the RH phase value are accumulated to acquire accumulated phase values (φ_{RH}, φ_{LH}).

Thereafter, an SFO value is calculated using a difference (φ_{RH}−φ_{LH}) between the accumulated phase values at step S60, as denoted by the following equation 2:

$$\begin{matrix}{ϕ}_{RH} = {\sum }_{k ∈ RH} {θ}_{k} \\ {ϕ}_{LH} = {\sum }_{k ∈ LH} {θ}_{k} \\ SFO ( ζ ) = {ϕ}_{RH} - {ϕ}_{LH}\end{matrix} \qquad [ Equation 2 ]$$

If the value of SFO(ζ) is estimated using the above-mentioned method, the present invention employs many more pilots (i.e., 142 pilots in the 2k mode and 568 pilots in the 8k mode) than those (i.e., 45 pilots in the 2k mode and 177 pilots in the 8k mode) of the conventional CP-associated method, such that it acquires sufficient phase information, resulting in a more correct SFO value. A detailed description will hereinafter be given with reference to annexed drawings.

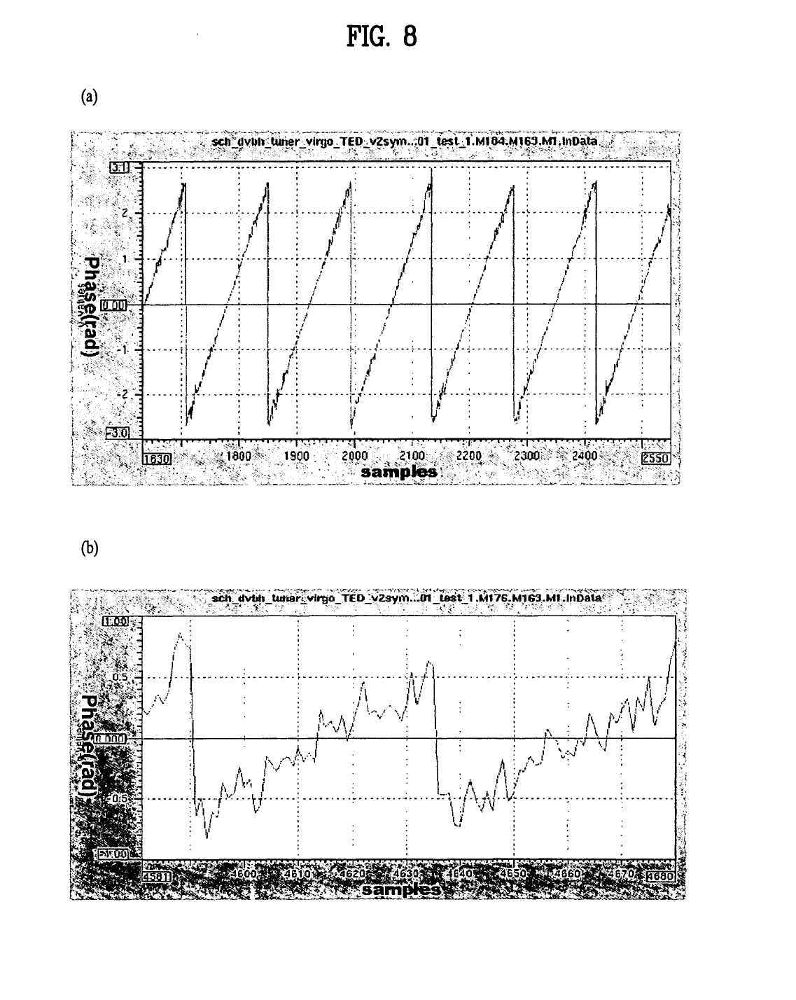

FIG. 8a is a graph illustrating a phase variation in the case of using a scattered pilot according to the present invention. Compared with the graph shown in FIG. 8a, FIG. 8b is a graph illustrating a conventional phase variation in the case of using a CP.

As shown in FIGS. 8a and 8b, a single period of a saw-toothed phase graph shows a phase rotation amount generated during a single symbol interval. It can be recognized that the graph of FIG. 8a in which the scattered pilot is employed has less phase scattering as compared to the other graph of FIG. 8b in which the CP is employed. In other words, a line of the phase graph in FIG. 8a is more smooth than that of the phase graph in FIG. 8b. In this manner, if the degree of phase scattering is reduced, a more correct SFO can be estimated.

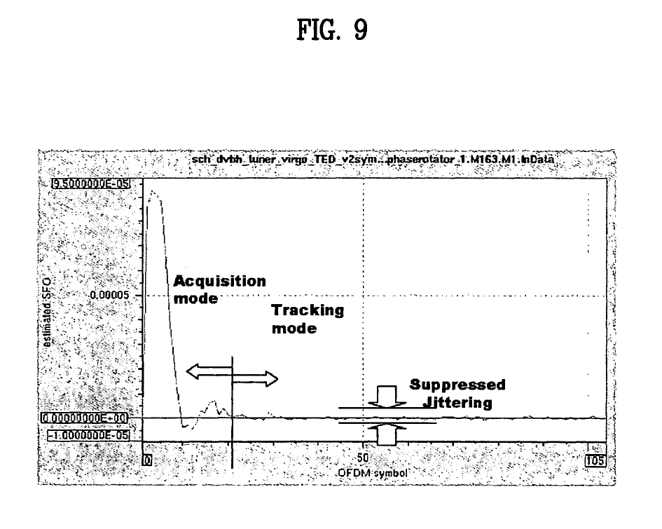

FIG. 9 shows estimated SFO values when phase overshoots are zero-forced in the tracking mode for use in an SFO estimation algorithm using the scattered pilot according to the present invention.

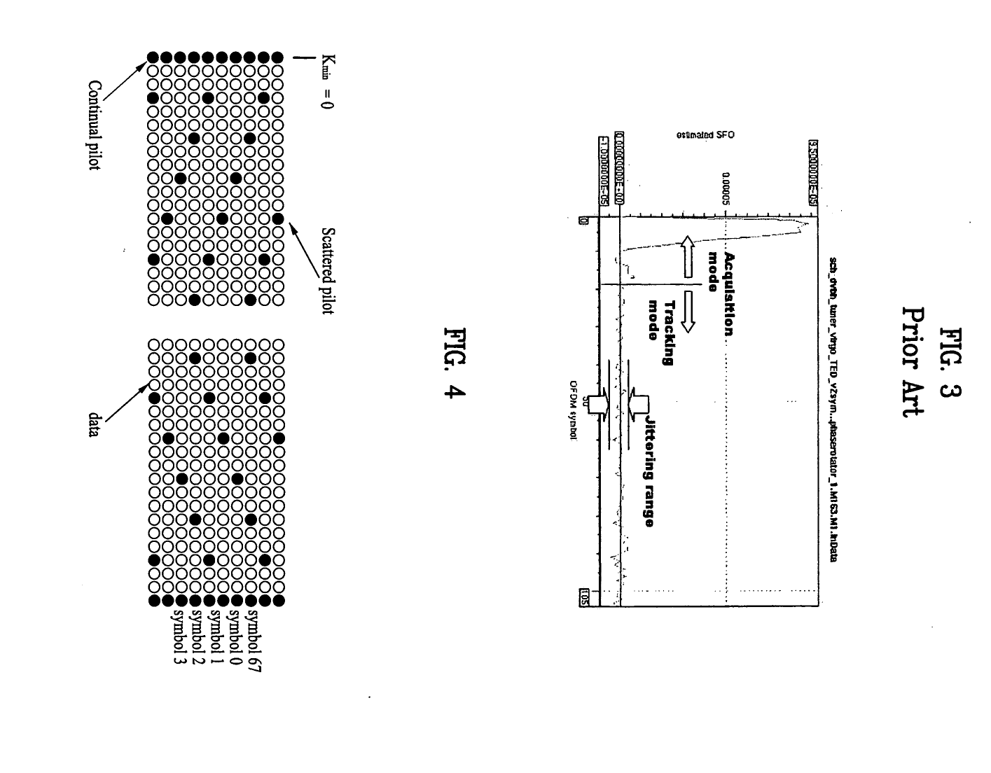

As shown in FIG. 9, if the estimated SFO value varying with time is compared with that of FIG. 3, it can be recognized that the jittering range is reduced in the tracking mode. The jittering range reduction is acquired by zero-forcing phase overshoots in the tracking mode. The jittering range reduction in the tracking mode is indicative of ISI (Inter Symbol Interference) reduction of a reception signal, and no constellation rotation occurs in the tracking mode.

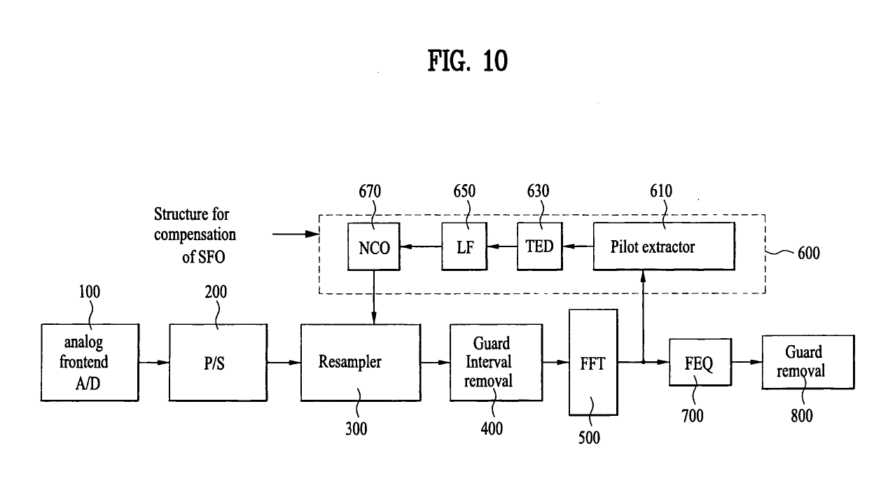

FIG. 10 is a block diagram illustrating an OFDM receiver according to the present invention.

Referring to FIG. 10, the OFDM receiver includes an analog front-end and ADC (Analog-to-Digital Converter) unit 100, a P/S (Parallel-to-Serial) unit 200, a resampler 300, a guard interval removal unit 400, an FFT (Fast Fourier Transform) unit 500, an SFO compensator 600, an FEQ (Freuqency-domain Equalizer) unit 700, and a guard removal unit 800. In more detail, the analog front-end and ADC unit 100 performs a front-end process on a received analog signal, and converts the received analog signal into a digital signal. The P/S unit 200 converts a received parallel signal into a serial signal. The resampler 300 performs a sampling process on a received signal using the sampling frequency generated by the estimated SFO. The guard interval removal unit 400 removes a guard interval of the received signal from a time domain. The FFT unit 500 converts a time-domain signal into a frequency-domain signal. The SFO compensator 600 performs correct sampling synchronization on the frequency-domain signal acting as the output signal of the FFT unit 500. The FEQ 700 performs channel equalization in a frequency domain. The guard remover unit 800 removes a guard interval from the frequency domain.

Particularly, the SFO compensator 600 according to the present invention includes a pilot extractor 610 for extracting a scattered pilot signal from the frequency-domain signal; a timing error detector 630 for receiving the extracted scattered pilot signal, and calculating a timing error value equal to the SFO value ζ using the extraction algorithm of the present invention; a loop filter (L/F) 650 for receiving the SFO value ζ, and accumulatively compensating for the received SFO value ζ, and a numerical controlled oscillator (NCO) 670 for controlling a sampling frequency upon receiving the compensated SFO value ζ from the L/F 650.

Therefore, the resampler 300 performs the sampling process using the resultant SFO value correctly estimated by the above-mentioned inventive method, such that correct sampling synchronization is provided.

The present invention is applicable to a DVB-T receiver and a DVB-H receiver.

As apparent from the above description, a method and apparatus for estimating an SFO in a digital receiver according to the present invention has the following effects.

Firstly, an SFO value is estimated by the scattered pilot, such that it can be more correctly estimated than in the conventional SFO estimation method based on the CP.

Secondly, the jittering range caused by overshoots is reduced by a zero-forcing algorithm, such that an SFO estimation failure caused by serious phase distortion can be solved.

Thirdly, correct sampling frequency compensation can be acquired by the estimated SFO value.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for estimating an SFO (Sampling Frequency Offset) in a digital receiver to perform sampling synchronization, comprising the steps of:
a) extracting a current scattered pilot contained in a single OFDM (Orthogonal Frequency Division Multiplexing) symbol interval;
b) calculating a phase value using both the extracted current scattered pilot and a delay value acquired when the current scattered pilot is delayed by four symbol intervals; and
c) estimating an SFO value using the calculated phase value.

2. The method according to claim 1, wherein the step b) for calculating the phase value includes the steps of:
b1) correlating the current scattered pilot with the delay value acquired when the current scatter pilot is delayed by four symbol intervals; and
b2) performing an arctangent operation on the resultant correlation value to acquire a desired phase.

3. The method according to claim 1, wherein the step c) for estimating the SFO value includes the steps of:
c1) receiving the estimated phase value, and determining the presence or absence of phase overshoots on the basis of the received phase value;
c2) if the phase overshoots occur, compulsorily setting the estimated phase value to zero, and storing the resultant phase value; and
c3) calculating the SFO value using the stored phase value.

4. The method according to claim 3, wherein the step c1) for determining the presence or absence of the phase overshoots includes the step of:
comparing a magnitude of the estimated phase value with that of a predetermined standard deviation, and determining the presence or absence of the phase overshoots according to the comparison result.

5. The method according to claim 4, wherein the predetermined standard deviation is 0.5 rad.

6. The method according to claim 3, wherein the step c1) for determining the presence or absence of the phase overshoots is performed when a current frequency estimation mode is a tracking mode.

7. The method according to claim 6, further comprising the step of:
if the frequency estimation mode is not equal to the tracking mode, storing the estimated phase value in a buffer, and calculating the SFO value using the stored phase value.

8. The method according to claim 3, further comprising the step of:
if no phase overshoot is determined, storing the estimated phase, and calculating the SFO value using the stored phase value.

9. The method according to claim 3, wherein the step c3) for calculating the SFO value includes the steps of:
c3-1) dividing the stored phase value into a left-half (LH) phase value and a right-half (RH) phase value on the basis of a center subcarrier, and accumulating each of the LH phase value and the RH phase value; and
c3-2) calculating a difference between the accumulated LH and RH phase values, and calculating the SFO value.

10. The method according to claim 9, wherein the SFO calculation is performed in a single symbol interval unit.

11. An apparatus for estimating a sampling frequency offset (SFO) in a digital receiver, comprising:
a phase estimator for receiving a scattered pilot contained in an OFDM (Orthogonal Frequency Division Multiplexing) symbol interval, and estimating a phase value using both a scattered pilot contained in a single symbol and a delay value acquired when the scattered pilot is delayed by four symbol intervals; and
an SFO calculator for calculating an SFO value using the estimated phase value.

12. An apparatus for estimating a sampling frequency offset (SFO) in a digital receiver, comprising:
a delay for receiving a scattered pilot contained in a single OFDM (Orthogonal Frequency Division Multiplexing) symbol interval, and delaying the received scattered pilot by four symbol intervals;
a conjugate calculator for calculating a conjugate root value of an output value of the delay;
a multiplier for correlating an output value of the conjugate calculator with the received scattered pilot;
a phase estimator for performing an arctangent operation on an output value of the multiplier to acquire a phase value; and
an SFO calculator for receiving an output value of the phase estimator, storing the received output value of the phase estimator during a predetermined interval, and calculating an SFO value using the stored phase value.

13. The apparatus according to claim 12, wherein the SFO calculator determines whether the presence or absence of phase overshoots in a tracking mode of a sampling frequency, and performs a zero-forcing operation when the presence of the phase overshoots is determined.

14. The apparatus according to claim 13, wherein the presence or absence of the phase overshoots is determined by comparing the estimated phase value with a predetermined standard deviation.

15. The apparatus according to claim 14, wherein the predetermined standard deviation is 0.5 rad.

16. The apparatus according to claim 12, wherein the SFO calculation using the estimated phase value is performed in a single symbol interval unit.

17. The apparatus according to claim 12, wherein the SFO calculator divides the stored phase value into a left-half (LH) phase value and a right-half (RH) phase value on the basis of a center subcarrier, accumulates each of the LH phase value and the RH phase value, calculates a difference between the accumulated LH and RH phase values, and calculates the SFO value.

18. A digital receiver apparatus, comprising:
a resampler for performing a sampling process on a received signal according to the calculated SFO value;
a guard interval removal unit for removing a guard interval of the received signal from a time domain;
a Fast Fourier Transform (FFT) unit for converting a time-domain signal into a frequency-domain signal; and
an SFO compensator for calculating the SFO value using a scattered pilot contained in an OFDM (Orthogonal Frequency Domain Multiplexing) symbol so as to perform correct sampling synchronization on the frequency-domain signal.

19. The apparatus according to claim 18, wherein the SFO compensator includes:
a pilot extractor for extracting a scattered pilot signal from the frequency-domain signal;
a timing error detector for receiving the extracted scattered pilot signal, estimating a phase value using both the scattered pilot contained in a single symbol and a delay value acquired when the scattered pilot is delayed by four symbol intervals, and calculating the SFO value using the estimated phase value;
a loop filter (L/F) for receiving the SFO value, and accumulatively compensating for the received SFO value; and
a numerical controlled oscillator (NCO) for controlling a sampling frequency upon receiving the compensated SFO value from the L/F unit.

20. The apparatus according to claim 18, wherein the digital receiver is a DVB-T (Digital Video Broadcasting-Terrestrial) system or a DVB-H (DVB-Handheld) system.
